(19) United States
(12) Patent Application Publication
(10) Pub. No.: US 2020/0205457 A1
(43) Pub. Date: Jul. 2, 2020

(54) Non-Traditional legume protein products such as: The legume protein bars, legume chocolate chip cookies, and legume rice crispy squares, presents an easier way to get the plant fiber from the legumes into our diets

(71) Applicant: Joe Ann Aiken, Sumter, SC (US)

(72) Inventor: Joe Ann Aiken, Sumter, SC (US)

(21) Appl. No.: 16/350,737

(22) Filed: Dec. 28, 2018

(51) Int. Cl. A23L 33/185; A23J 3/14; A23L 11/00

(52) U.S. Cl. CPC A23L 33/185; A23L 11/05; A23J 3/14

(57) ABSTRACT

These delicious and nutritious legume protein treats have natural plant protein that provides the building blocks for healthy muscles and tissues. Fiber is beneficial for weight loss, these treats are loaded with fiber, and other nutritional benefits.

### CROSS REFERENCE TO RELATED APPLICATION

This application claims the benefits of U.S. provisional application No. 62/707,081, filed Oct. 23, 2017, the disclosure of which is incorporated herein by reference.

### STATEMENT REGARDING FEDERALLY SPONSORED RESEARCH OR DEVELOPMENT

“Not Applicable”

### BACKGROUND OF INVENTION

“Individuals are malnourished, or suffer from under nutrition if their diets does not provide them with adequate calories and protein for maintenance and growth, or they cannot fully utilize the food they eat due to illness.”

“According to the World Health Organization (WHO), malnutrition is the gravest single threat to global public health.”

“Malnutrition is the condition that develops when the body is deprived of vitamins, minerals and other nutrients it needs to maintain healthy tissues and organ function.”

“Malnourished children may be short for their age, thin or bloated, listless and have weakened immune systems. Nutritional disorders can affect any system in the body and the senses of sight, taste and smell. They also produce anxiety, changes in moods and other psychiatric symptoms.”

“There are two basic types of malnutrition/undernutrition. The first and most important is protein-energy malnutrition (PEM). It is basically a lack of calories and protein. Food is converted into energy by humans, and the energy contained in food is measured by calories. Protein is necessary for key body functions including provision of essential amino acids and development and maintenance of muscles. Protein-energy malnutrition is the more lethal form of malnutrition/hunger and is the type of malnutrition that is referred to when world hunger is discussed. This leads to growth failure.”

“Beans are a super healthy, super versatile and super affordable food. Beans are high in antioxidants, fiber, protein, B vitamins, iron, magnesium, potassium, copper and zinc. Eating beans regularly may decrease the risk of diabetes, heart disease, colorectal cancer, and help weight management. Beans are hearty, helping you feel full so you will tend to eat less.”

“Magnesium is a mineral that's crucial to the body's function. Magnesium helps keep blood pressure normal, bones strong, and the heart rhythm steady.”

Rich in energy-giving carbohydrates, with a low glycemic index rating for blood glucose control. A good source of B-group vitamins (especially folate), iron, zinc, calcium and magnesium. Low in sodium—sodium content of canned legumes can be reduced by up to 41% if the product is drained and rinsed.

Legumes are among the best plant-based source of dietary protein.

### SUMMARY OF INVENTION

I have found creative ways of incorporating powdered legumes into baked goods making the products more nutritious, and making it easier for children and adults alike to consume legumes. I have created and incorporated legumes in the following products: The legume protein bars, the legume chocolate chip cookies, and the legume rice crispy squares. These products will make it easier for all to get the much needed nutrients that legume has to offer, with ease.

### DETAILED DESCRIPTION OF DRAWINGS

“Not Applicable”

### DETAILED DESCRIPTION OF THE INVENTION

Legume Chocolate Chip Cookies, Legume Protein Bar, and Legume Rice Crispy Squares. Once the legumes are powdered, the powder can be incorporated in just about anything, making it a more healthier food product with added protein and fiber.

How the legumes are processed to be powdered:
1. (a) Soak the legumes overnight.
(b) Cook the legumes in water on top of the stove between 10-15 minutes on high heat.
(c) Drain the water from the legumes.
(d) Place the legumes on a cookie sheet.
(e) Place the legumes in a preheated oven between 325-350 degrees Fahrenheit and let cook between 10-20 minutes.
(f) Turn the oven to low and let legumes dehydrates until completely dried out.
2. Legumes can be processed without soaking, follow the instruction in b-f in #1 above. After dehydration, let the legumes cool, and then place them in a blender and grind into powder, spread the legume powder out onto parchment paper and let cool. Store the legume powder in a dry airtight container or zip lock bag until ready to use.
3. Legumes can be powdered from the original state, (just place the legumes into a blender and grind into powder, spread the legumes out on a piece of parchment paper, let cool and store in a dry airtight container or zip lock bag until ready to use.
   Note: Legumes can be soaked, fermented, sprouted, or powdered from its raw state.
   Legumes are among the best plant-based source of dietary protein.

1. Legume Protein Bar comprising of:
a. Between ½-¾ cup pumpkin seeds
b. ¼-½ cup sesame seeds
c. 2 Tablespoon ground flax seed
d. ½ cup legume flour
e. ¼ cup nutritional yeast
f. ¼ cup vegetable oil
g. ½ cup shredded coconut
h. ½-1 cup chopped mixed nuts
i. 1-1½ cup chocolate chips
j. ½-1 teaspoon salt
k. ½ cup raisins
l. ¼ cup oats
m. Melt the chocolate chips in a sauce pan and remove from the heat. Combine all the other ingredients with the chocolate, and mixed until all the ingredients are coved with chocolate. Pour ingredients into a lightly greased baking pan about one inch deep, and spread evenly. Let cool, and cut into bars.

2. Legume chocolate chip cookies comprising of:
a. 1 cup unbleached flour
b. 1 c legume flour
c. ½ c sugar
d. ½ teaspoon salt
e. 1 teaspoon baking powder
f. 1 cup chocolate chips
g. ¼ cup vegetable oil
h. 1 cup applesauce
i. 2 tablespoons ground flax seed
j. 2 tablespoons nutritional yeast
k. Mix all ingredients together in a mixing bowl. Scoop the dough onto parchment with a small scooper. Bake for 10-12 minutes at 350 degrees (f).

3. Legume Rice Crispy Squares comprising of:
a. 4-5 cups
b. 5-7 cups of marshmallows
c. ¼ cup legume powder (Flour)
d. 2 tablespoon nutritional yeast
e. ½ cup chopped nuts (optional)
f. Melt the marshmallows in a glass bowl in the microwave for approximately 1½ minutes. While still warm, stir in the remaining ingredients until completely cover with the marshmallows. Spoon the mixture into a baking pan or glass dish. Take a piece of wax paper and press evenly into the pan, let cool, cut into squares. The mixture can be put into individual molds.
